(19) United States
(12) Patent Application Publication
(10) Pub. No.: US 2006/0063085 A1
(43) Pub. Date: Mar. 23, 2006

(54) Electrophotographic developing agent

(75) Inventors: Duck-hee Lee, Seoul (KR); Sang-deok Kim, Seoul (KR); Seok-hoon Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/145,952

(22) Filed: Jun. 7, 2005

(30) Foreign Application Priority Data
Sep. 23, 2004 (KR) 10-2004-0076347

(51) Int. Cl. G03G 9/08

(52) U.S. Cl. 430/108.22; 430/108.6; 430/108.7

(57) ABSTRACT

An electrophotographic developing agent is provided. The electrophotographic developing agent includes toner particles and an external additive. The toner particles include a binder resin, a colorant, and a charge control agent. The external additives which are added to the toner particles include a large-diameter silica having a primary average particle size of about 20 to about 200 nm, a small-diameter silica having a primary average particle size of about 5 to about 20 nm, a hydrophobic titanium oxide, and a polymer bead. The electrophotographic developing agent can maintain a stable charge and charge distribution of the toner over a long period due to the addition of the external additives. The external additives prevent the fogging and the image contamination in a cycle of a charging roller.

### CROSS-REFERENCE TO RELATED APPLICATION

This application claims the benefit under 35 U.S.C. § 119 of Korean Patent Application No. 10-2004-0076347, filed on Sep. 23, 2004, in the Korean Intellectual Property Office, the disclosure of which is incorporated herein in its entirety by reference in its entirety.

### BACKGROUND OF THE INVENTION

1. Field of the Invention

The present invention relates to an electrophotographic developing agent and to a toner containing electrophotographic developing agent. More particularly, the invention is directed to an electrophotographic developing agent which maintains a stable charge and charge distribution of a toner over an extended lifetime, thereby preventing fogging and image contamination that occurs during a cycle of a charging roller.

2. Description of the Related Art

Electrophotographic image processing apparatuses, such as laser printers, facsimiles, copying machines, etc. are now widely used. These apparatuses produce desired images by forming a latent image on a photoreceptor by utilizing a laser, moving a toner onto the latent image on the photoreceptor using an electrical potential difference to form an image, and then transferring the image onto a printing media such as paper.

Recently, image forming apparatuses, such as laser beam printers (LBPs) for electrophotographs, multifunction machines, color copying machines, etc. are widely used that require high image qualities. Thus, developing agents used in developing members are designed to stabilize a charge, development efficiency, resist anti-fogging caused by time-related changes due to image printing over a long period as well as against the affects of environmental changes.

To control the charge stabilization, anti-fogging, development efficiency, etc. of the toner, attention has been given to add various external additives of the toner, such as silica, TiO₂, Al₂O₃, etc. However, improvements of the image qualities have been limited. The charging properties of the toner vary greatly according to the environmental conditions, for example, low temperature and low humidity, or high temperature and high humidity, etc. In addition, although the charge and charge distribution of the toner are uniform at the initial time of printing, the charge of the toner greatly decreases over time, or the charge of the toner decreases and the charge distribution is not uniform after printing a large number of images, which cause fogging and scattering of the toner.

Thus, the number of external additives, which are added to the toner to improve various image qualities, are increasing and the amounts of the external additives used are gradually increasing. It is advantageous that these external additives are stable and constantly attached to a surface of the toner over a long-period printing. However, in practice, the external additives become embedded into the toner particles or some of the external additives become separated/detached from the toner, thereby contaminating the developing members and the resulting images being printed. It is observed that as the particle sizes of the external additives and aggregation forces between them increase, a larger amount of the external additives are separated/detached from the toner. The separation and detachment of the external additives become more serious with an increase in the number and amount of the external additives being used.

Japanese Laid-Open Patent Publication No. 2000-003066 describes a negatively charged, non-magnetic one-component toner for static charge development which can form a sufficient image, the toner comprising the two types of fine hydrophobic silica particles which have different average particle diameters from each other and organic particulates. Japanese Laid-Open Patent Publication No. 2003-202702 describes a negatively charged toner comprising two types of silicas which have different average particle diameters from each other and hydrophobic titanium oxide as external additives.

However, the above toners cannot maintain a stable attachment of the external additives to the toner particles when printing a large number of images, and thus, can cause image contamination of the printing apparatus and the resulting printed image.

### SUMMARY OF THE INVENTION

The present invention provides an electrophotographic developing agent which can maintain a stable charge and charge distribution of a toner during changes of environmental conditions as well as changes caused by printing a large number of images. The electrophotographic developing agent of the invention is able to prevent fogging, and can prevent image contamination caused by the contamination of developing members due to the separation or detachment of external additives from the toner particles.

The present invention also provides an electrophotographic image forming apparatus using the above electrophotographic developing agent of the invention.

According to an aspect of the present invention, an electrophotographic developing agent is provided that comprises: toner particles comprising a binder resin, a colorant, and a charge control agent; and external additives which are added to the toner particles. The external additives comprise a large-diameter silica having a primary average particle size of about 20 to about 200 nm, a small-diameter silica having a primary average particle size of about 5 to about 20 nm, a hydrophobic titanium oxide, and a polymer bead.

These and other aspects of the invention will become apparent from the following detailed description of the invention, which in conjunction with the drawings, disclose various embodiments of the invention.

### BRIEF DESCRIPTION OF THE DRAWINGS

The above and other features and advantages of the present invention will become more apparent by describing in detail exemplary embodiments thereof with reference to the attached drawing in which:

FIG. 1 is a schematic view of an electrophotographic apparatus which operates in a non-contact developing mode according to an embodiment of the present invention.

### DETAILED DESCRIPTION OF THE INVENTION

Hereinafter, the present invention will be described in more detail.

The present invention provides an electrophotographic developing agent comprising:
toner particles comprising a binder resin, a colorant, and a charge control agent; and
external additives which are added to the toner particles,
wherein the external additives comprise a large-diameter silica having a primary average particle size of about 20 to about 200 nm, a small-diameter silica having a primary average particle size of about 5 to about 20 nm, a hydrophobic titanium oxide, and a polymer bead.

In conventional polymerized or pulverized toners, a colorant, a charge control agent, a releasing agent, etc. are uniformly and internally (not externally) added into a binder resin to improve the chromaticity, charging property, and fusing property of the toner. Also, various types of external additives are added to the toners to increase the mobility, charge stability, and cleaning property, etc. of the toner When external additives are added to the toners, the external additives become detached or separated from the toner particles or are embedded into the toner particles, thereby causing deterioration of the images produced by the toners. At least two types of external additives which have different average particle sizes are used together in the present invention to prevent the external additives from being detached from or embedded into the toner particles.

The electrophotographic developing agent is produced by adding and admixing the additives to toner particles. The toner particles are first prepared by mixing a binder resin, a colorant and a charge control agent in a suitable mixing apparatus. The resulting mixture is then typically heated in an extruder to melt the binder resin and disperse the colorant and charge control agent in the binder resin. The melt is extruded, cooled and pulverized to obtain the toner particles. The toner particles are then mixed with the external additives to coat the surface of the toner particles with the additives.

In the electrophotographic developing agent according to an embodiment of the present invention, two types of silicas having different particle sizes may be used as inorganic particulates. The silicas may comprise a large-diameter silica having a primary average particle size of about 20 to about 200 nm and a small-diameter silica having a primary average particle size of about 5 to about 20 nm. The large-diameter silica serves as spacer particles to prevent deterioration of the toner by improving the durability of the toner and to improve the transfer property of the toner. The small-diameter silica mainly acts to impart mobility to the toner.

The amounts of the large-diameter silica and the small-diameter silica are respectively in a range of about 0.1 to about 3.0 parts by weight, based on 100 parts by weight of the parent toner particles. If the amount is less than 0.1 parts by weight, the desirable effects of adding the silicas cannot be easily obtained. If the amount is more than 3.0 parts by weight, the fusing property can decrease and excessive charging and poor cleaning property, etc. can occur.

Although the transfer efficiency can be greatly increased by using only the silica having a relatively large specific surface area, a drum can be contaminated after a large number of images are printed. Thus, other inorganic particulates may be used in addition to the silicas to attain a significant increase in the transfer efficiency. Examples of inorganic particulates that can be used include titanium oxides, aluminum oxides, zinc oxides, magnesium oxides, cerium oxides, iron oxides, copper oxides, and tin oxides, etc. Preferably, a hydrophobic titanium oxide is used.

In an embodiment of the present invention, the hydrophobic titanium oxide is used to increase the mobility of the toner by controlling the average particle size of the toner. The hydrophobic titanium oxide is used together with the silicas having the two different primary average particle sizes. In addition, when the hydrophobic titanium oxide is used, high transfer efficiency can be maintained even after a large number of images are printed. In addition, contamination of a drum can be prevented, thereby increasing the environmental stability. The hydrophobic titanium oxide also prevents a charge-up of the toner occurring at a low temperature and a low humidity and prevents a charge-down of the toner occurring at a high temperature and a high humidity. Preferably, the hydrophobic titanium oxide has a primary average particle diameter of about 10 to about 500 nm, and more preferably, about 10 to about 100 nm. If the average particle diameter is larger than 500 nm, the charge-down may occur at a high temperature and a high humidity. If the average particle diameter is smaller than 10 nm, the fusing property may deteriorate and charge uniformity cannot be easily attained. The hydrophobic titanium oxide particles are as known by those skilled in the art of electrophotographic developing agents. Commercially available hydrophobic titanium oxides can be used that typically are formed from titanium oxide particles that are treated with a hydrophobic agent.

The amount of the hydrophobic titanium oxide may vary according to the concentrations of the two types of silicas. The amount of the hydrophobic titanium oxide is preferably in a range of about 0.1 to about 2.0 parts by weight, and more preferably, about 0.1 to about 1.5 parts by weight, based on 100 parts by weight of the parent toner particles. If the amount of the hydrophobic titanium oxide is less than 0.1 parts by weight, based on 100 parts by weight of the parent toner particles, the effect of removing the contaminants from the drum may be decreased, and thus, there is a risk of increasing image contamination. If the amount of the hydrophobic titanium oxide is more than 2.0 parts by weight, based on 100 parts by weight of the parent toner particles, a value of frictional charge may decrease, and thus, the desired images cannot be obtained.

In addition to the above additives, a polymer bead may be added to the electrophotographic developing agent according to an embodiment of the present invention. The polymer bead is used to prevent image contamination which is caused by the contamination of the developing members. The examples of the polymer bead include a melamine-based bead or polymethylmethacrylate (PMMA). Preferably, the polymer bead has a primary average particle size of about 0.1 to about 3 μm, and more preferably, about 0.2 to about 2 μm. If the average particle size is smaller than 0.1 μm, the image contamination cannot be prevented. If the average particle size is larger than 3 μm, the polymer bead can be easily separated or detached from the toner. The melamine-based bead and the PMMA may be used alone or in combination with each other. The total amount of the polymer beads is preferably in a range of about 0.1 to about 2.0 parts by weight, based on 100 parts by weight of the parent toner particles. If the total amount of the polymer beads is less than 0.1 parts by weight, the image contamination cannot be prevented. If the total amount of the polymer beads is more than 2.0 parts by weight, the polymer beads may separate or detach from the toner and aggregate by themselves.

The parent toner particles may comprise a binder resin, a colorant, a charge control agent, and a releasing agent.

Various known resins can be used as the binder resin. Examples of the binder resin include polystyrene, poly-p-chlorostyrene, poly-α-methylstyrene, styrene based copolymer such as styrene-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-propylacrylate copolymer, styrene-butylacrylate copolymer, styrene-octylacrylate copolymer, styrene-methylmethacrylate copolymer, styrene-ethylmethacrylate copolymer, styrene-propylmethacrylate copolymer, styrene-butylmethacrylate copolymer, styrene-α-chloromethylmethacrylate copolymer, styrene-acrylonitrile copolymer, styrene-vinylmethylether copolymer, styrene-vinylethylether copolymer, styrene-vinylethylketone copolymer, styrene-butadiene copolymer, styrene-acrylonitrile-indene copolymer, styrene-maleic acid copolymer, and styrene-maleic ester; polymethylmethacrylate, polyethylmethacrylate, polybutylmethacrylate, and copolymers thereof, polyvinyl chloride, polyvinyl acetate, polyethylene, polypropylene, polyester, polyurethane, polyamide, epoxy resin, polyvinylbutyral resin, rosin, modified rosin, terpene resin, phenol resin, aliphatic or alicyclic hydrocarbon resin, aromatic petroleum resin, chlorinated paraffin and paraffin wax, and the like, or a combination thereof. The binding resin may be used alone or in a mixture of two or more. Among these binding resins, polyester resin has an excellent fusing property and transparency and is suitable for use in a color developer.

The electrophotographic developing agent may comprise the colorant. Carbon black or aniline black may be used as the colorant for a black and white toner. The non-magnetic toner according to an embodiment of the present invention may be a color toner that can be easily produced. Carbon black is commonly used to obtain a black color. Yellow, magenta, and cyan colorants are used to obtain chromatic colors.

The examples of the yellow colorant include a condensed nitrogen compound, an isoindolinone compound, an anthraquinone compound, an azo-metal complex, or an allyl imide compound. Specifically, C.I. PIGMENT YELLOW 12, 13, 14, 17, 62, 74, 83, 93, 94, 95, 109, 110, 111, 128, 129, 147, or 168, etc. may be used.

The examples of the magenta colorant include a condensed nitrogen compound, an anthraquinone compound, a quinacridone compound, a basic dye lake compound, a naphthol compound, a benzimidazole compound, a thioindigo compound, or a perylene compound. Specifically, C.I. PIGMENT RED 2, 3, 5, 6, 7, 23, 48:2, 48:3, 48:4, 57:1, 81:1, 144, 146, 166, 169, 177, 184, 185, 202, 206, 220, 221, or 254, etc. may be used.

The examples of the cyan colorant include a copper phthalocyanine compound and its derivatives, an anthraquinone compound, or a basic dye lake compound. Specifically, C.I. PIGMENT BLUE 1, 7, 15, 15:1, 15:2, 15:3, 15:4, 60, 62, or 66, etc. may be used.

The colorant may be used alone or as mixtures of two or more. The colorant is selected in consideration of the color, saturation, brightness, weather resistance, dispersibility in the toner, etc.

The amount of the colorant may be sufficient to dye a toner and form a visible image by development. For example, the colorant can be in the range of about 2 to about 20 parts by weight, based on 100 parts by weight of the binder resin. If the amount of the colorant is less than 2 parts by weight, sufficient coloring effects cannot be attained. If the amount of the colorant is more than 20 parts by weight, the electrical resistance of the toner is reduced and sufficient frictional charge cannot be obtained, thus causing contamination.

The charge control agent used in the electrophotographic developing agent according to an embodiment of the present invention may be a negative-charge control agent or a positive-charge control agent. Examples of a negative-charge control agent include an organic metal complex, such as a chromium-containing azo dye or monoazo metal complex, or a chelating compound; a salicylic compound containing a metal, such as chromium, iron, or zinc; and an organic metal complex with an aromatic hydroxycarboxylic acid or an aromatic dicarboxylic acid. Other charge control agents can be used as known in the art. The examples of the positive-charge control agent include a product modified with nigrosine and its fatty acid metal salt, etc., and an onium salt containing a quaternary ammonium salt, such as tributylbenzylammonium 1-hydroxy-4-naphthosulfonate and tetrabutylammonium tetrafluoroborate; or a combination thereof. The charge control agent may be used alone or as a mixture of two or more. The charge control agent ensures that the toner is stably supported on the developing roller by an electrostatic force, thereby allowing for a stable and rapid charging speed.

The amount of the charge control agent in the toner composition is generally in a range of about 0.1 to about 10 parts by weight, based on 100 parts by weight of the total toner particles.

The toner particles used in an embodiment of the present invention may further comprise a releasing agent, a higher fatty acid or its metal salt, etc. Examples of a suitable releasing agent include polyalkylene wax, such as, low molecular weight polypropylene, low molecular weight polyethylene, ester wax, carnauba wax, paraffin wax, higher fatty acid, fatty acid amide, etc. The higher fatty acid or its metal salt can be used to protect a photoreceptor and prevent the deterioration of the developing properties, thus obtaining high quality images.

The colorant may be previously flushing-treated or used as a melt-kneaded master batch with a resin, having a high concentration of the colorant, to ensure a uniform dispersion in the binder resin. For example, the binder resin and the colorant as the essential components may be mixed using kneading means, such as, a 2-roll, 3-roll, press kneader, or a twin-screw extruder. The colorant must be uniformly dispersed in the mixture and the melt-kneading is performed at 80-180° C. for 10 minutes to 2 hours. Then, the mixture is pulverized using a pulverizer. Examples of pulverizers include a jet mill, an attritor mill, or a rotary mill, and the like, to produce the toner particles having an average particle size of about 3 to about 15 μm. The external additives are attached to the toner particles to improve powder mobility and charging stability of the toner particles.

The electrophotographic developing agent according to an embodiment of the present invention may be prepared using a polymerization method as well as a melt-kneading pulverization method. The external additives may be attached to the toner particles by mixing the toner particles and the external additives in a predetermined ratio and stirring the mixtures in a stirring apparatus. Examples of a stirring apparatus include a HENSCHEL mixer to coat the external additives to the surfaces of the toner particles or by stirring the toner particles and the external additives in a surface modifier, for example, “NARA HYBRIDIZER” to embed at least a portion of the external additives into the surface of the toner particles for fixing. Other mixing devices can be used to admix the toner particles with the external additives. The external additives are admixed in a manner to uniformly disperse the components so that the additives form a uniform, substantially homogeneous mixture of toner particles and the additive.

A conventional image forming process comprises a charging process in which a constant charge is imparted to a photoreceptor composed of a photoconductive material; an exposing process in which latent image is formed on the photoreceptor using a laser; a developing process in which the toner image is formed by developing the latent image on the photoreceptor using a developing agent; a transferring process in which the toner image is transferred to a transfer material such as paper; a fusing process in which the toner transferred to the transfer material is fused using heat or pressure; and a cleaning process in which toners and residues remaining on a carrier of the latent image are cleaned. By repeating the process steps, the desired copies or printed products are obtained. The developing process is classified into a contacting-type and a non contacting-type. In the contacting-type developing process, a developing agent is developed on the latent image by contacting a developing roller with a surface of a photoreceptor. In the non contacting-type developing process, the developing roller and the surface of the photoreceptor are separated by a predetermined distance, and the developing agent is moved by electrical forces generated by an electrical potential difference between the developing roller and the latent image on the photoreceptor. The contacting-type developing process is disadvantageous because the photoreceptor and the developing roller wear away The non contacting-type developing process is advantageous because of the superior durability of the apparatus and the excellent resolution of the image obtained using electrical forces.

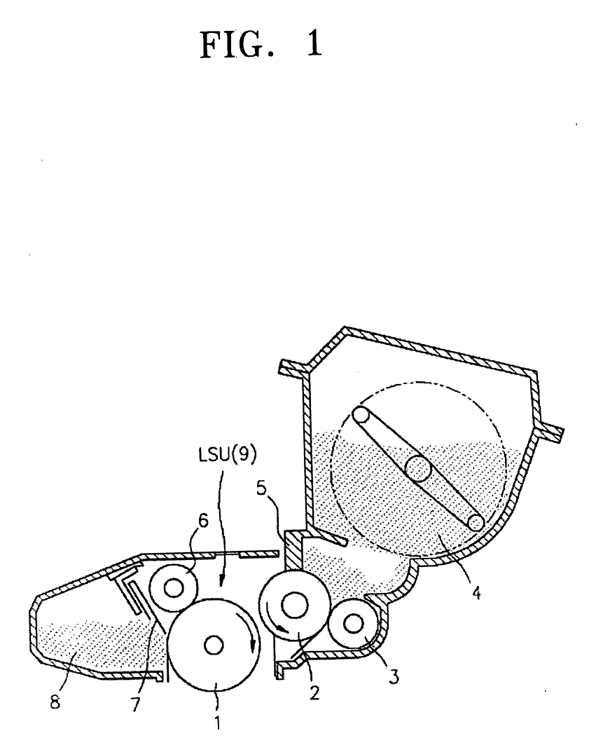

FIG. 1 is a schematic view illustrating an electro-photographic apparatus using a non-contacting non-magnetic one-component toner according to an embodiment of the present invention. Referring to FIG. 1, a photoreceptor 1 is charged by a charging unit 6, and then a latent image is formed on the photoreceptor 1 by photo-exposing the image with a laser-scanning unit (LSU) 9. A non-magnetic toner 4 is fed to a developing roller 2 by a feeding roller 3. A thin layer of the toner with a uniform thickness is formed on the developing roller 2 by a toner layer regulation unit 5, and simultaneously, the toner is highly charged by friction. The toner which passes through the regulation unit 5 is developed on an electrostatic latent image formed on the photoreceptor 1, and the developed toner is transferred to a sheet of paper using a transfer roller (not shown), and then fused using a fusing apparatus (not shown). After transferring the toner to a sheet of paper, the remaining toner on the photoreceptor 1 is cleaned by a cleaning blade 7. The reference numeral 8 represents the waste toner.

The electrophotographic developing agent according to an embodiment of the present invention can be used in an electrophotographic apparatus using a contacting non-magnetic one-component developing toner, as well as in an electrophotographic apparatus using the non-contacting non-magnetic one-component toner. Also, the electrophotographic developing agent can be used as both a negatively charged toner and a positively charged toner.

According to another embodiment of the present invention, there is provided an electrophotographic apparatus using an electrophotographic developing agent, the electrophotographic developing agent comprising toner particles comprising a binder resin, a colorant, and a charge control agent; and external additives which are added to the toner particles, wherein the external additives comprise a large-diameter silica having a primary average particle size of about 20 to about 200 nm, a small-diameter silica having a primary average particle size of about 5 to about 20 nm, a hydrophobic titanium oxide, and a polymer bead.

Hereinafter, the present invention will be described in detail with reference to the following examples and not intended to limit the scope of the invention.

### EXAMPLE 1

Preparation of Toner Particles

90.5 parts by weight of polyester having a weight average molecular weight of 100,000, 5 parts by weight of carbon black (manufactured by Mitsubishi Chemical Co., Ltd.), 2.5 parts by weight of a negative-charge control agent (manufactured by Hodogaya Co., Fe complex), and 2 parts by weight of a low molecular weight polypropylene wax (manufactured by Sanyo Chemical Industries Co.) were premixed using a HENSCHEL type mixer. Then, the resultant mixture was charged into a twin-screw extruder and melted and extruded at 130° C. The resultant product was cooled to coagulate the mixture. The untreated toner having an average particle diameter of about 8 μm was obtained using a pulverizing classifier.

### EXAMPLE 2

The following external additives were externally added to the above untreated toner obtained in Example 1 to prepare a toner according to an embodiment of the present invention. The external additives were combined with the toner particles and uniformly mixed together to coat the external surfaces of the toner particles with the additives.

External additives:
Large-diameter silica (primary average particle diameter: 30-50 nm) 1.0% by weight
Small-diameter silica (primary average particle diameter: 7-16 nm) 1.0% by weight
Titanium oxide (primary average particle diameter: 10-50 nm) 0.5% by weight, and
melamine-based bead (primary average particle diameter: 300-500 nm) 0.5% by weight.

### COMPARATIVE EXAMPLE 1

The following external additives were externally added to the above untreated toner of Example 1 to prepare a toner. The additives were mixed with the toner particles as in Example 2.

External additives:
The first silica (primary average particle diameter: 30-50 nm) 1.0% by weight
The second silica (primary average particle diameter: 7-16 nm) 1.0% by weight, and
Titanium oxide (primary average particle diameter: 10-50 nm) 0.5% by weight.

### COMPARATIVE EXAMPLE 2

The following external additives were externally added to the above untreated toner of Example 1 to prepare a toner. The additives were mixed with the toner particles as in Example 2.

External additives:
The first silica (primary average particle diameter: 30-50 nm) 1.0% by weight
The second silica (primary average particle diameter: 7-16 nm) 1.0% by weight, and
Melamine-based bead (primary average particle diameter: 300-500 nm) 0.5% by weight.
   <Image Evaluation Test (Based on a Negatively Charged Toner)>

Images were evaluated for the toners obtained in Example 2, and Comparative Examples 1 and 2, using a 20 ppm-grade LBP printer. The image density (I/D), fogging (background (B/G), contamination in a non-image area), and image contamination occurring during in a cycle of a charging roller (CR) were measured to evaluate the performances of the tones. The image density was obtained by measuring the density of a solid pattern on a sheet of paper and fogging was evaluated by measuring the density of the toner in a non-image area of a photoreceptor using a densitometer (SpectroEye, GretagMacbeth Co.). The image contamination in a cycle of the CR was evaluated visually. The operational conditions of the developing apparatus were as follows:
Surface potential (Vo): −700 V
Latent image potential (VL): −100 V
Voltage applied to developing roller: Vp−p=1.8 KV, frequency=2.0 kHz,
   Vdc=−500 V, duty ratio=35% (square wave)
Developing gap: 150-400 μm
Developing roller:
   (1) Aluminum roller
      Roughness: Rz=1-2.5 (after plating with nickel)
   (2) Rubber roller (NRB-based elastic rubber roller)
      Resistance: 1×10⁵-5×10⁶ Ω
      Hardness: 50
Toner: Charge amount (q/m)=−5 to −30 μC/g
(measured on the developing roller after passing through a layer regulating unit)
Amount of toner per area=0.3 to 1.0 mg/cm²
   <Results of Image Evaluation (Based on a Negatively Charged Toner)>

The evaluation results of the image density for the toners are listed in Table 1.

TABLE 1

| | Initial | 1,000 | 2,000 | 3,000 | 4,000 | 5,000 |
|---|---|---|---|---|---|---|
| Example 2 | ◯ | ◯ | ◯ | ◯ | ◯ | Δ |
| Comparative | ◯ | ◯ | ◯ | ◯ | Δ | Δ |
| Example 1 | | | | | | |
| Comparative | ◯ | ◯ | ◯ | ◯ | Δ | Δ |
| Example 2 | | | | | | |

The evaluation results of the fogging for the toners are listed in Table 2.

TABLE 2

| | Initial | 1,000 | 2,000 | 3,000 | 4,000 | 5,000 |
|---|---|---|---|---|---|---|
| Example 2 | ◯ | ◯ | ◯ | ◯ | ◯ | Δ |
| Comparative | ◯ | ◯ | ◯ | ◯ | Δ | Δ |
| Example 1 | | | | | | |
| Comparative | ◯ | ◯ | ◯ | Δ | X | X |
| Example 2 | | | | | | |

The evaluation results of the Image contamination in a cycle of the CR for the toners are listed in Table 3.

TABLE 3

| | Initial | 1,000 | 2,000 | 3,000 | 4,000 | 5,000 |
|---|---|---|---|---|---|---|
| Example 2 | ◯ | ◯ | ◯ | ◯ | ◯ | ◯ |
| Comparative | ◯ | Δ | Δ | X | X | X |
| Example 1 | | | | | | |
| Comparative | ◯ | ◯ | ◯ | ◯ | ◯ | ◯ |
| Example 2 | | | | | | |

Evaluation Basis

The evaluation rating for I/D is as follows: “O”: more than 1.3, “Δ”: 1.1-1.3, and “X”: less than 1.1.

The evaluation rating for B/G (fogging) is as follows: “O”: less than 0.14, “Δ”: 0.14-0.17, and “X”: more than 0.17.

The evaluation rating for the image contamination in a cycle of the CR is as follows: “O”: when there was no problem, as judged visually, and “X”: there was a serious problem, as judged visually.

As seen from the above experimental results, for the toner obtained in Example 2, in which the hydrophobic titanium oxide and the melamine-based bead (the polymer bead) were used as the external additives, all of the image density, prevention of fogging, and prevention of image contamination in a cycle of the CR were improved. For Comparative Example 1, in which only the hydrophobic titanium oxide was used as the external additive, fogging, especially image contamination in a cycle of the CR was increased with the increasing number of pages. For Comparative Example 2, in which only the melamine-based bead was used as the external additive, fogging was remarkably increased without image contamination in a cycle of the CR. Thus, it was confirmed that the hydrophobic titanium oxide can prevent fogging and the melamine-based bead can prevent image contamination in a cycle of the CR.

The electrophotographic developing agent according to the present invention uses the two types of silicas which have different average particle sizes from each other, the hydrophobic titanium oxide, and the polymer bead as the external additives, thereby preventing fogging and image contamination in a cycle of the CR. The electrophotographic developing agent according to the present invention may be used in various electrophotographic forming apparatuses.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic developing agent comprising:
toner particles comprising a binder resin, a colorant, and a charge control agent; and
external additives which are added to the toner particles,
wherein the external additives comprise a large-diameter silica having a primary average particle size of about 20 to about 200 nm, a small-diameter silica having a primary average particle size of about 5 to about 20 nm, a hydrophobic titanium oxide, and a polymer bead.

2. The electrophotographic developing agent of claim 1, wherein amounts of the large-diameter silica and the small-diameter silica are respectively in a range of about 0.1 to about 3.0 parts by weight, based on 100 parts by weight of the toner particles.

3. The electrophotographic developing agent of claim 1, wherein the hydrophobic titanium oxide has an average particle size of about 10 to about 500 nm.

4. The electrophotographic developing agent of claim 3, wherein the hydrophobic titanium oxide has an average particle size of about 10 to about 100 nm.

5. The electrophotographic developing agent of claim 3, wherein the amount of the hydrophobic titanium oxide is in a range of about 0.1 to about 2.0 parts by weight, based on 100 parts by weight of the toner particles.

6. The electrophotographic developing agent of claim 1, wherein the polymer bead has an average particle size of about 0.1 to about 3 μm.

7. The electrophotographic developing agent of claim 6, wherein the amount of the polymer bead is in a range of about 0.1 to about 2.0 parts by weight, based on 100 parts by weight of the toner particles.

8. The electrophotographic developing agent of claim 1, wherein the polymer bead is a melamine-based bead or polymethylmethacrylate (PMMA)-based bead.

9. The electrophotographic developing agent of claim 1, wherein the polymer bead is a melamine-based bead.

10. The electrophotographic developing agent of claim 1, wherein said electrophotographic developing agent is produced by admixing the toner particles with the external additives to form a homogeneous mixture.

11. The electrophotographic developing agent of claim 1, wherein said external additives are uniformly dispersed with the toner particles and wherein said external additives adhere to an external surface of the toner particles.

12. An electrophotographic image forming apparatus using the electrophotographic developing agent of claim 1.
